(19) United States
(12) Patent Application Publication
(10) Pub. No.: US 2005/0105454 A1
(43) Pub. Date: May 19, 2005

(54) Methods and devices for recording marks on a recording surface of an optical record carrier and optical record carriers therefor

(75) Inventor: Hubert Cecile Francois Martens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronice N.V.

(21) Appl. No.: 10/504,758

(22) PCT Filed: Feb. 21, 2003
(86) PCT No.: PCT/IB03/00620

(30) Foreign Application Priority Data
Feb. 22, 2002 (EP) 02075728.2

(51) Int. Cl. G11B 7/24

(52) U.S. Cl. 369/275.1

(57) ABSTRACT

The invention relates to methods, devices and carriers for forming marks and lands by applying a radiation beam to a recording surface of an optical record carrier. Recording strategies are proposed for recording information mainly for DVR-R (BD-R) formats. A sequence of portions 2, 4, 5 of a write irradiation period 3 is proposed.

The invention relates to an optical record carrier recording method for forming marks and lands by applying a radiation beam to a recording surface of an optical record carrier, the marks having a time length of nT, where T represents the time length of one period of a reference clock in a data signal and n represents a predetermined natural number, where the radiation beam for each mark to be recorded is first set to a intermediate power irradiation level, the intermediate power irradiation level being higher than bottom power irradiation level and lower than write power irradiation level, where the intermediate power irradiation level is set in accordance with a time length of the preceding bottom power irradiation period.

The invention also relates to an optical record carrier recording method for forming marks and lands by applying a radiation beam to a recording surface of an optical record carrier, the marks having a time length of nT, where T represents the time length of one period of a reference clock in a data signal and n represents a predetermined natural number smaller than 3, where the radiation beam for each mark to be recorded is first set to a intermediate power irradiation level, the intermediate power irradiation level being higher than bottom power irradiation level and lower than write power irradiation level, where the intermediate power irradiation level is set in accordance with a time length of the preceding bottom power irradiation period.

The invention also relates to optical recording devices for carrying out such methods.

The invention also relates to optical carriers capable of having such methods applied to them.

A recording method of the kind set in the preamble is known from a patent application WO 01/86643. In a solution presented in the patent application a mark is formed by applying a radiation beam to a recording surface of an optical record carrier set to have an intermediate power level after the bottom power level and before the write power level. Furthermore, a mark is formed by applying a radiation beam having write power level and elevated power level to a recording surface of an optical record carrier in the first and the second portion of the write power irradiation period respectively. The preferred elevated power level is set to be within the range from 1.05 to 1.15 times the write power level and from 1.00 to 1.08 times the write power level for marks to be recorded having a time length of 3T and 4T respectively. The recording method allows to reduce a jitter and is especially applicable to CD-R systems.

It is an object of an invention to provide a method of recording marks of the kind described in the opening paragraph which is better suitable to DVR-R (BD-R) format.

This object is achieved by a method as described in the preamble which is characterized in that after the intermediate power irradiation period, the radiation beam for each mark to be recorded is set to the write power irradiation level during a first and a third portions of a write irradiation period. Whereas the radiation beam for each mark to be recorded is set to an elevated write power level during a second portion of the write irradiation period. The elevated write power level is higher than the write power level. Both the elevated write power level and the duration of the second portion of the write irradiation period are being set in accordance with a time length of a mark to be recorded.

This object is also achieved by a method as described in the preamble which is characterized in that after the intermediate power irradiation period, the radiation beam for each mark to be recorded is set to an elevated write power irradiation level during a first portion of a write irradiation period. Whereas the radiation beam for each mark to be recorded is set to the write power level during a second portion of the write irradiation period. The elevated write power level is higher than the write power level. Both the elevated write power level and the duration of the first portion of the write irradiation period are being set in accordance with a time length of the mark to be recorded.

A preferred version of the method according to the invention is characterized in that where n equals 2 the elevated write power level is set to be lower than 2.0 times the write power level. Where n equals 3, the elevated write power level is set to be lower than 1.7 times the write power level; where n equals 4, the elevated write power level is set to be lower than 1.5 times the write power level; and where n is larger than 4, the elevated write power level is set to be lower than 1.4 times the write power level.

Another feature characterizing a preferred version of the method according to the invention is that where the duration of the length of a preceding bottom power irradiation period is smaller than 2T, the intermediate power irradiation level is set to be lower than 0.5 times the write power level. The duration of the length of a preceding bottom power irradiation period is equal to 3T, the intermediate power irradiation level is set to be within the range from 0.3 to 0.8 times the write power level; where the duration of the length of a preceding bottom power irradiation period is equal to 4T, the intermediate power irradiation level is set to be within the range from 0.4 to 0.9 times the write power level; and where the duration of the length of a preceding bottom power irradiation period is greater than 4T, the intermediate power irradiation level is set to be greater than 0.5 times the write power level.

This object of an invention is also achieved by a method as described in the preamble for marks having a time length of nT, where T represents the time length of one period of a reference clock in a data signal and n represents a predetermined natural number smaller than 3, which is characterized in that after the intermediate power irradiation period the radiation beam for each mark to be recorded is set to the write power irradiation level during a first portion of a write irradiation period. Whereas the radiation beam for each mark to be recorded is set to an elevated write power level during a second portion of the write irradiation period and where the elevated write power level is higher than the write power level.

It is a further object of the invention to provide an optical recording device for carrying out the methods according to the invention. This object is achieved by optical recording devices which have features as described in claim 14 or claim 15 or claim 16.

It is a further object of the invention to provide an optical record carrier where the parameters for carrying out the methods according to the invention are pre-recorded in the appropriate part of the optical record carrier. This object is achieved by optical recording devices which have features as described in claim 17.

Although the invention is explained by using a DVR-R (BD-R) system as an example, it will be apparent to those skilled in the art that the invention may be applied to alternative optical recording systems.

The objects, features and advantages of the invention well be apparent from the following, more specific description of embodiments of the invention as illustrated in the accompanying drawings, wherein:

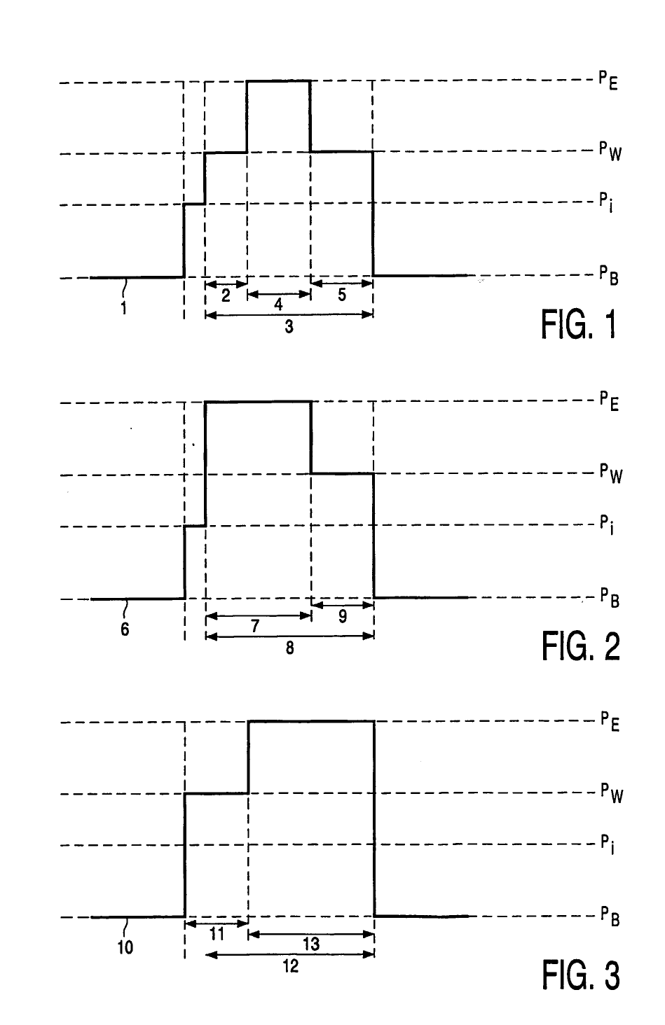

FIG. 1 shows a diagram of a first version of a method according to the invention,

FIG. 2 shows a diagram of a second version of a method according to the invention,

FIG. 3 shows a diagram of a third version of a method according to the invention, and

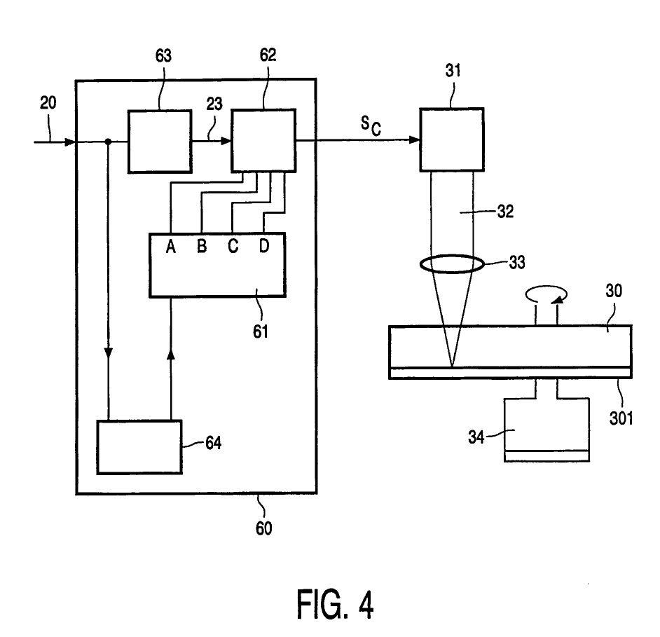

FIG. 4 shows a diagram of an optical recording device according to the invention.

FIG. 1 shows a control signal 1 for controlling the power of the radiation beam. When a mark is recorded, the control signal 1, and hence the power of the radiation beam, is first set from bottom power level P_{B} to intermediate power level Pᵢ and then is set to the write power P_{W} during the first portion 2 of the write irradiation period 3 and subsequently it is set to the elevated write power level P_{E} during the second portion 4 of the write irradiation period 3. Afterwards, the control signal 1, and hence the power of the radiation beam, is set again to the write power P_{W} during the third portion 5 of the write irradiation period 3 and then it is set to bottom power level P_{B}.

FIG. 2 shows a control signal 6 for controlling the power of the radiation beam. When a mark is recorded, the control signal 6, and hence the power of the radiation beam, is first set from bottom power level P_{B} to intermediate power level Pᵢ and then is set to the elevated write power P_{E} during the first portion 7 of the write irradiation period 8. Afterwards, the control signal 6, and hence the power of the radiation beam, is set to the write power P_{W} during the second portion 9 of the write irradiation period 8 and then it is set to bottom power level P_{B}.

FIG. 3 shows a control signal 10 for controlling the power of the radiation beam. When a mark is recorded, the control signal 10, and hence the power of the radiation beam, is first set from bottom power level P_{B} to the write power P_{W} during the first portion 11 of the write irradiation period 12. Afterwards, the control signal 10, and hence the power of the radiation beam, is set to the elevated write power P_{E} during the second portion 13 of the write irradiation period 12 and then it is set to bottom power level P_{B}.

FIG. 4 shows an optical recording device according to the invention for recording a data signal 20 on the recording surface 301 of a disc-shaped optical record carrier. The optical record carrier is rotated around its center by a motor 34. A radiation beam 32 is generated by a radiation source 31 and focused onto the recording surface 301 by a lens 33.

The data signal 20 is connected to control means 60. A current source 61 within the control means 60 has four outputs, A, B, C and D. Output A provides a current which, when fed to the radiation source 31 through a control signal S_{C}, will produce the radiation beam 32 having a write power level P_{W}. Likewise, outputs B, C and D provide currents resulting in the elevated write power level P_{E}, the bottom power level P_{B} and the intermediate power level Pᵢ, respectively. The current of each output A, B, C and D can be selected by a switch-unit 62 within the control means 60. The switch-unit 62 is operated by a pattern generator 63 controlled by the data signal 20. The pattern generator 63 transforms the data signal 20 into a control signal 23.

The control means 60 also comprise setting means 64 for setting the current of the outputs B and D of the current source 61. The current of output B of the current source 61 is set in dependence on the length of the duration of elevated power level periods. Thus, by setting the current of output B, the elevated write power level is set in dependence on the length of the mark to be recorded. The current of output D of the current source 61 is set in dependence on duration of the bottom power period preceding the write power period, thus, by setting the current of output D, the intermediate power level is set in dependence on the length of the land preceding the mark to be recorded.

FIG. 3 shows an embodiment of an optical recording device according to the invention. However, it will be apparent to those skilled in the art that embodiments of an optical recording device using more power levels can be realized by adding further outputs to the current source 61 and by extending the switch-unit 62. Moreover, it will be apparent that a single output B, respectively D, of the current source 61 providing a varying current can, as an alternative, be replaced by several outputs, each providing a different current, while the setting means 64 select the appropriate output for setting the elevated write power level and the intermediate power level, respectively, at any time.

1. An optical record carrier recording method for forming marks and lands by applying a radiation beam to a recording surface of an optical record carrier, the marks having a time length of nT,
where T represents the time length of one period of a reference clock in a data signal and n represents a predetermined natural number, where the radiation beam for each mark to be recorded is first set to an intermediate power irradiation level, the intermediate power irradiation level being higher than a bottom power irradiation level and lower than a write power irradiation level,
where the intermediate power irradiation level is set in accordance with a time length of the preceding bottom power irradiation period, characterized in that
after the intermediate power irradiation period, the radiation beam for each mark to be recorded is set to the write power irradiation level during a first and a third portions of a write irradiation period,
whereas the radiation beam for each mark to be recorded is set to an elevated write power level during a second portion of the write irradiation period,
where the elevated write power level is higher than the write power level, and
where both the elevated write power level and the duration of the second portion of write irradiation period are being set in accordance with a time length of a mark to be recorded.

2. An optical record carrier recording method for forming marks and lands by applying a radiation beam to a recording surface of an optical record carrier, the marks having a time length of nT,
where T represents the time length of one period of a reference clock in a data signal and n represents a predetermined natural number,
where the radiation beam for each mark to be recorded is first set to an intermediate power irradiation level, the intermediate power irradiation level being higher than a bottom power irradiation level and lower than a write power irradiation level,
where the intermediate power irradiation level is set in accordance with a time length of the preceding bottom power irradiation period, characterized in that
after the intermediate power irradiation period, the radiation beam for each mark to be recorded is set to an elevated write power irradiation level during a first portion of a write irradiation period,
whereas the radiation beam for each mark to be recorded is set to the write power level during a second portion of the write irradiation period,
where the elevated write power level is higher than the write power level, and
where both the elevated write power level and the duration of the first portion of write irradiation period are being set in accordance with a time length of the mark to be recorded.

3. An optical record carrier recording method as claimed in claim 1, characterized in that the elevated write power level for recording a mark having a time length nT is set to be higher than the elevated write power level for recording a mark having a time length (n+1)T.

4. An optical record carrier recording method as claimed in claim 1, where n equals 2, characterized in that the elevated write power level is set to be lower than 2.0 times the write power level.

5. An optical record carrier recording method as claimed in claim 1, where n equals 3, characterized in that the elevated write power level is set to be lower than 1.7 times the write power level.

6. An optical record carrier recording method as claimed in claim 1, where n equals 4, characterized in that the elevated write power level is set to be lower than 1.5 times the write power level.

7. An optical record carrier recording method as claimed in claim 1, where n is larger than 4, characterized in that the elevated write power level is set to be lower than 1.4 times the write power level.

8. An optical record carrier recording method for forming marks and lands by applying a radiation beam to a recording surface of an optical record carrier, the marks having a time length of nT,
where T represents the time length of one period of a reference clock in a data signal and n represents a predetermined natural number smaller than 3,
where the radiation beam for each mark to be recorded is first set to an intermediate power irradiation level, the intermediate power irradiation level being higher than a bottom power irradiation level and lower than a write power irradiation level,
where the intermediate power irradiation level is set in accordance with a time length of the preceding bottom power irradiation period, characterized in that
after the intermediate power irradiation period the radiation beam for each mark to be recorded is set to the write power irradiation level during a first portion of a write irradiation period,
whereas the radiation beam for each mark to be recorded is set to an elevated write power level during a second portion of the write irradiation period,
where the elevated write power level is higher than the write power level.

9. An optical record carrier recording method as claimed in claim 8, characterized in that the elevated write power level is set to be lower than 2.0 times the write power level.

10. An optical record carrier recording method as claimed in claim 1, where the duration of the length of a preceding bottom power irradiation period is smaller than 2T, characterized in that the intermediate power irradiation level is set to be lower than 0.5 times the write power level.

11. An optical record carrier recording method as claimed in claim 1, where the duration of the length of a preceding bottom power irradiation period is equal to 3T, characterized in that the intermediate power irradiation level is set to be within the range from 0.3 to 0.8 times the write power level.

12. An optical record carrier recording method as claimed in claim 1, where the duration of the length of a preceding bottom power irradiation period is equal to 4T, characterized in that the intermediate power irradiation level is set to be within the range from 0.4 to 0.9 times the write power level.

13. An optical record carrier recording method as claimed in claim 1, where the duration of the length of a preceding bottom power irradiation period is greater than 4T, characterized in that the intermediate power irradiation level is set to be greater than 0.5 times the write power level.

14. An optical recording device for recording data in the form of marks and lands on a recording surface of an optical record carrier by irradiating the recording surface by means of a radiation beam, the device comprising a radiation source for providing the radiation beam and control means for controlling the power of the radiation beam such as that it has at least one write power level capable of forming a mark during a write power irradiation period and that it has at least one bottom power level incapable of forming a mark during a bottom power irradiation period and that is has at least one intermediate power level being higher than bottom power level and lower than write power level where the control means are operative to set the intermediate power irradiation level in accordance with a time length of the preceding bottom power irradiation period, characterized in that the control means are operative to control the power of the radiation beam after the intermediate power irradiation period such that it has
the write power level capable of forming a mark during a first and a third portions of a write irradiation period, and
the elevated write power level capable of forming a mark during a second portion of a write irradiation period,
where the elevated write power level is higher than the write power level, and
where both the elevated write power level and the duration of the second portion of write irradiation period are being set in accordance with a time length of a mark to be recorded.

15. An optical recording device for recording data in the form of marks and lands on a recording surface of an optical record carrier by irradiating the recording surface by means of a radiation beam, the device comprising a radiation source for providing the radiation beam and control means for controlling the power of the radiation beam such as that it has at least one write power level capable of forming a mark during a write power irradiation period and that it has at least one bottom power level incapable of forming a mark during a bottom power irradiation period and that is has at least one intermediate power level being higher than bottom power level and lower than write power level where control means are operative to set the intermediate power irradiation level in accordance with a time length of the preceding bottom power irradiation period, characterized in that the control means are operative to control the power of the radiation beam after the intermediate power irradiation period such that it has
the elevated write power level capable of forming a mark during a first portion of a write irradiation period, and
the write power level capable of forming a mark during a second portion of a write irradiation period,
where the elevated write power level is higher than the write power level, and where both the elevated write power level and the duration of the first portion of write irradiation period are being set in accordance with a time length of a mark to be recorded.

16. An optical recording device for recording data in the form of marks and lands on a recording surface of an optical record carrier by irradiating the recording surface by means of a radiation beam, the device comprising a radiation source for providing the radiation beam and control means for controlling the power of the radiation beam such as that it has at least one write power level capable of forming a mark of a length of 2T during a write power irradiation period, where T represents the time length of one period of a reference clock in data signal and that it has at least one bottom power level incapable of forming a mark during a bottom power irradiation period and that is has at least one intermediate power level being higher than bottom power level and lower than write power level where the control means are operative to set the intermediate power irradiation level in accordance with a time length of the preceding bottom power irradiation period, characterized in that the control means are operative to control the power of the radiation beam after the intermediate power irradiation period such that it has
the write power level capable of forming a mark during a first portion of a write irradiation period, and
the elevated write power level capable of forming a mark during a second portion of a write irradiation period, and
where the elevated write power level is higher than the write power level.

17. An optical record carrier for recording data in the form of marks and lands by irradiating its recording surface by means of a radiation beam characterized in that intermediate power level parameters, elevated write power level parameters and parameters denoting duration of elevated write power level portion of write irradiation period are recorded on the optical record carrier.
